(19) United States
(12) Patent Application Publication
(10) Pub. No.: US 2015/0029162 A1
(43) Pub. Date: Jan. 29, 2015

(54) METHODS AND APPARATUS FOR PROVIDING UNIVERSAL STYLUS DEVICE WITH FUNCTIONALITIES

(71) Applicant: FiftyThree, Inc., New York, NY (US)

(72) Inventors: Jonathan R. HARRIS, Redmond, WA (US); John K. IKEDA, Seattle, WA (US); James KOO, Renton, WA (US)

(73) Assignee: FiftyThree, Inc, New York, NY (US)

(21) Appl. No.: 14/340,287

(22) Filed: Jul. 24, 2014

Related U.S. Application Data
(60) Provisional application No. 61/857,810, filed on Jul. 24, 2013.
(60) Provisional application No. 61/857,809, filed on Jul. 24, 2013.
(60) Provisional application No. 61/905,651, filed on Nov. 18, 2013.

(51) Int. Cl. G06F 3/0488; G06F 3/0354

(52) U.S. Cl. CPC G06F 3/0488; G06F 3/03545
USPC 345/179

(57) ABSTRACT

A method can include receiving a signal representing a first touch event and receiving a signal representing a first end portion of a stylus device being activated. Based on receiving the signal representing the first touch event and based on receiving the signal representing the first end portion of the stylus device being activated, a signal can be sent such that a graphical user interface (GUI) is modified according to a first functionality. A signal representing a second touch event and a signal representing a second end portion of the stylus device being activated can also be received. Based on receiving the signal representing the second touch event and based on receiving the signal representing the second end portion of the stylus device being activated, a signal can be sent such that the GUI is modified according to a second functionality.

### CROSS REFERENCE TO RELATED APPLICATIONS

This application claims priority under 35 U.S.C. §119(e) to Provisional U.S. Patent Application No. 61/857,810, filed Jul. 24, 2013, entitled “Methods and Apparatus for Providing Universal Stylus Device with Functionalities,” the disclosure of which is incorporated herein by reference in its entirety. This application also claims priority under 35 U.S.C. §119(e) to Provisional U.S. Provisional Patent Application No. 61/857,809, filed Jul. 24, 2013, and to Provisional U.S. Patent Application No. 61/905,651, filed Nov. 18, 2013, each entitled “Methods and Apparatus for Implementing Dual Tip Functionality in a Stylus Device,” and each of which is incorporated herein by reference in its entirety.

This application is related to co-pending Non-Provisional U.S. patent application having Attorney Docket No. FIFT-008/02US 317784-2028, filed Jul. 24, 2014, entitled “Methods and Apparatus for Implementing Dual Tip Functionality in a Stylus Device,” which is incorporated herein by reference in its entirety.

This application is related to Provisional U.S. Patent Application No. 61/857,812, filed Jul. 24, 2013 and co-pending Non-Provisional U.S. patent application having Attorney Docket No. FIFT-012/01US 317784-2032, filed on Jul. 24, 2014, each entitled “Stylus Having a Deformable Tip and Methods of Using the Same,” and each of which is incorporated herein by reference in its entirety.

This application is related to Provisional U.S. Patent Application No. 61/857,817, filed Jul. 24, 2013 and co-pending Non-Provisional U.S. patent application having Attorney Docket No. FIFT-013/01US 317784-2034, filed on Jul. 24, 2014, each entitled “Stylus Having a Deformable Tip and Methods of Using the Same,” and each of which is incorporated herein by reference in its entirety.

### BACKGROUND

Some embodiments described herein relate generally to methods and apparatus for providing multiple-tipped functionality on electronic pens or stylus devices for computing devices such as electronic tablets. More specifically, the embodiments described herein relate to providing a stylus device with various functionalities associated with different portions of the stylus device.

Known computing devices, such as desktop computers, laptop computers, and tablet computers support a wide variety of inputs, including touch-based inputs. A number of input technologies, such as resistive touch screens, capacitive touch screens, optical tracking, etc., support such touch-based inputs. Some such technologies allow a user to interact with the compute device by making a gesture, drawing a shape, writing letters, etc. using his or her finger and/or a stylus device. A stylus device can be analogous to a pen or pencil and can allow the user to exercise greater control over the input as compared to using his or her finger.

Known touch-based input systems, however, are typically operable only to detect contact. Thus, known touch-based input systems are typically unable to distinguish between different styluses and/or between the two end portions of the stylus device. As a result, a stylus device typically does not have dual functionality such as, for example, a first end portion for drawing and/or writing and a second end portion for erasing.

Therefore, a need exists for an approach to enable a stylus device to recognize and adapt to the computing platform with which it interacts and to enable a stylus device to operate over a large range of angles across multiple surfaces.

### SUMMARY

In some embodiments, a method can include receiving a signal representing a first touch event, associated with, for example, a stylus device contacting a touchscreen of a host device and receiving a signal representing a first end portion of a stylus device being activated. The signal representing the first end portion of the stylus device being activated can be sent in response to an elastomeric external member being moved from an unbiased configuration to a biased configuration. Based on receiving the signal representing the first touch event and based on receiving the signal representing the first end portion of the stylus device being activated, a signal can be sent such that a graphical user interface (GUI) is modified according to a first functionality. For example, a mark can be added to the GUI. A signal representing a second touch event and a signal representing a second end portion of the stylus device being activated can also be received. Based on receiving the signal representing the second touch event and based on receiving the signal representing the second end portion of the stylus device being activated, a signal can be sent such that the GUI is modified according to a second functionality. For example, at least a portion of the mark can be subtracted from the GUI.

### BRIEF DESCRIPTION OF THE DRAWINGS

FIG. 1 is a schematic block diagram of a computer system configured to provide functions of stylus device with multiple-tipped functionality, according to an embodiment.

FIG. 2 is a schematic illustration of a stylus management platform, according to an embodiment.

FIG. 3A is a cross sectional view of a stylus device with two end portions, according to an embodiment.

FIG. 3B is an illustration of a stylus device, according to an embodiment.

FIGS. 4A-4C are sample illustrations of flip-to-erase functionality of a stylus device, according to an embodiment.

FIGS. 5A-5D are sample illustrations of flip-to-modify functionality of a stylus device, according to an embodiment.

FIGS. 6A-6B are sample illustrations of ink-smear functionality of a stylus device, according to an embodiment.

FIGS. 7A-7B are sample illustrations of pencil-effect functionality of a stylus device, according to an embodiment.

FIGS. 8A-8B are sample illustrations of marker-effect functionality of a stylus device, according to an embodiment.

FIGS. 9A-9B are sample illustrations of pen-effect functionality of a stylus device, according to an embodiment.

FIGS. 10A-10C are sample illustrations of wet-brush functionality of a stylus device, according to an embodiment.

### DETAILED DESCRIPTION

Methods and apparatus are described herein, for example, to provide universal stylus devices with multiple-tipped functionality. In some embodiments, a stylus device includes multiple switch mechanisms, for example, disposed at the stylus tip portion, disposed at the stylus end portion, etc. The stylus device also includes a wireless transceiver that allows the stylus device to communicate to a host device (e.g., an electronic tablet) data associated with a function (e.g., an illustration) by a user on the host device using the stylus device. The stylus device can be activated independently from software, for example, solely by the wireless transceiver. This enables activation of, for example, a wide range of multiple stylus device functions associated with applications of the host device. For example, the stylus device can be used to write, color, and/or draw with a tip portion of the stylus device and then can be flipped to another tip (e.g., end portion) to erase, blend, and/or smear as a user would generally do with a conventional pencil or other illustration tools on paper. In various embodiments, methods comprise receiving input from the stylus device and receiving input from an input module (e.g., a touch screen) and sending signals to modify a GUI according to various functions.

In some embodiments, a stylus device has a switch mechanism at each end portion of the stylus along with a wireless transceiver. This allows the stylus to communicate to a tablet device when the user touches or contacts the tablet (e.g., draws) with the stylus tip portion or the stylus end portion. Such functionality can enable a wide range of multiple-sided stylus functions for host device applications. For example, a user of a host device can use a stylus device to draw with one tip and then flip the stylus device to erase the drawing similar to using a pencil on paper. As another example, a stylus device can have a marker color tip on one side and a color blender on another tip.

In some instances, a tip end portion of a stylus device has a shape that allows for touch contact to a screen to occur over a relatively large range of incident angles from a vertical direction (e.g., substantially perpendicular to the screen surface) to almost a horizontal direction (e.g., a 70 degrees angle). The shape of an end tip portion and, for example, the wall section of the tip portion of the stylus device can provide responsiveness for variable and light actuation forces across the range of angles.

In some instances, a stylus device enables a user to use the stylus device with a natural hand posture, allowing for natural use over a large range of angles across surface of the tip end portion. The stylus device can provide a flip-to-function (e.g., flip to erase) functionality similar to an intuitive and natural user interaction model of a pencil. Similarly stated, a second functionality can be applied without the user selecting the function from a GUI, menu, pushing a button, or taking any other action other than applying an end of the stylus device to the host device. In some instances, a stylus device can reject palm touches, for example, by detecting whether a touch or contact on the screen is with a stylus device or without a stylus device and eliminating multiple touch effects on a screen of a host device. As used herein, “user” can be a person, a module, a device, or an application. In some of the embodiments discussed, a user is referred to as a person using the host device via one or more user interfaces such as a stylus device on the surface of the host device. Additionally or alternatively, a user can be a device, a module of a device, or an application such as, for example, art applications, computer games, simulation applications, etc., that can use the functionalities provided and managed by the described methods and apparatus.

In some instances, a stylus device can include a tip portion and an end portion. The tip portion can include an external conductive element separated by a gap from an internal conductive element. The external conductive element and the internal conductive element can each be coupled to a body of the stylus device. In some instances, the external conductive element and/or the gap can be outside the body. For example, the external conductive element can be externally coupled to the body and/or the gap can be defined by a portion of the external conductive element that extends from the body of the housing. The tip portion can also include other material such as, for example, foam. The external conductive element can be made of an elastomeric material (e.g., rubber) and is a movable part that deforms when the end portion is in contact with a surface of a screen of a host device. The internal conductive element can be, for example, a stationary part or can be a moveably part. The end portion can also include an external conductive element separated by a gap from an internal conductive element. The internal conductive element of both portions is connected to a voltage source.

In some instances, when a specific portion of the stylus device is in contact with the screen surface, for example, during writing, drawing, erasing, etc., force is applied to the external conductive element. The external conductive element can deform (i.e., change configuration e.g., to a biased configuration) and come into physical and electrical contact with the stationary internal conductive element to produce a closed circuit that can allow current to flow from a voltage source. The closed circuit can activate a switch to the “closed” configuration with regards to the end portion of the stylus device that is in contact with the host device. The activated switch can send an electronic signal to a processor. Because each end portion is connected to a different input pin (or channel) of the processor, the processor can identify the switch that is in the active mode. In alternative embodiments, the closed circuit can deactivate the switch to the “open” configuration.

In some instances, each portion of the stylus device can implement multiple functionalities. In such instances, that include multiple functionalities at each portion of the stylus device, a separate activation mechanism can be used for each functionality, so that a user or an application (e.g., an application running on the host device, on the stylus device, etc.) can select one functionality from two or more possible choices for a given portion of the stylus device.

In some embodiments, a method can include receiving a signal representing a first touch event, associated with, for example, a stylus device contacting a touchscreen of a host device and receiving a signal representing a first end portion of a stylus device being activated. The signal representing the first end portion of the stylus device being activated can be sent in response to an elastomeric external member being moved from an unbiased configuration to a biased configuration. Based on receiving the signal representing the first touch event and based on receiving the signal representing the first end portion of the stylus device being activated, a signal can be sent such that a graphical user interface (GUI) is modified according to a first functionality. For example, a mark can be added to the GUI. A signal representing a second touch event and a signal representing a second end portion of the stylus device being activated can also be received. Based on receiving the signal representing the second touch event and based on receiving the signal representing the second end portion of the stylus device being activated, a signal can be sent such that the GUI is modified according to a second functionality. For example, at least a portion of the mark can be subtracted from the GUI.

In some embodiments, a method can include receiving an indication of a first touch event from an input module and receiving a signal from a stylus device representing a first end portion of the stylus device being activated. The signal representing the first end portion of the stylus device being activated can be sent in response to a gap that is entirely external (e.g., distal) to a housing of the stylus device being closed. Based on receiving the indication of the first touch event and based on receiving the signal representing the first end portion of the stylus device being activated, a GUI can be modified according to a first functionality. An indication of a second touch event can be received from the input module and a signal representing a second end portion of the stylus device being activated can be received from the input module. Based on receiving the indication of the second touch event and based on receiving the signal representing the second end portion of the stylus device, the GUI can be modified according to a second functionality.

In some embodiments, an apparatus can include a modification module operatively coupled to an input module, a communication module, and a presentation module. The input module can be configured to detect touch events. The communication module can be configured to receive signals associated with a first end portion or a second end portion of a stylus device being activated. For example, a stylus device can send a signal associated with an end portion being activated when a tip member deforms to move a switch to a closed configuration. The switch can be biased in the open configuration and/or the tip member can be biased in an undeformed configuration. The modification module can be configured to send a signal to the presentation module to cause a first modification of a GUI based on the input module detecting a first touch event and the communication module receiving a signal associated with the first end portion of the stylus device being activated. The modification module can further be configured to send a signal to the presentation module to cause a second modification of a GUI based on the input module detecting a second touch event and the communication module receiving a signal associated with the second end portion of the stylus device being activated.

As used herein, the singular forms “a,” “an” and “the” include plural referents unless the context clearly dictates otherwise. Thus, for example, the term “a “stylus device” is intended to mean a single stylus device or a combination of stylus devices (e.g., multiple stylus devices used by a user on a host device).

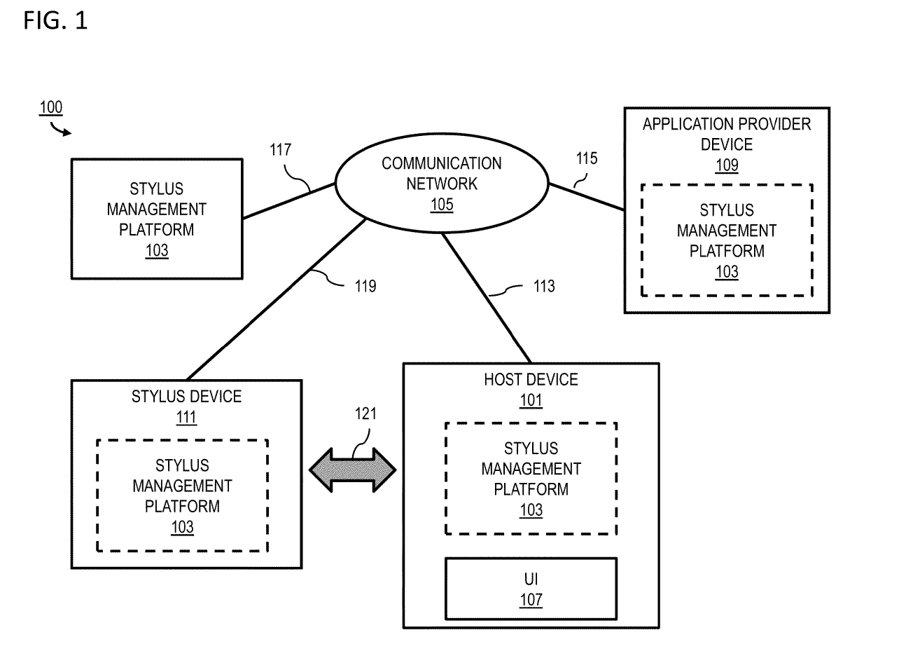

FIG. 1 is a schematic block diagram of a computer system configured to be used by a stylus device with multiple-tipped functionality, according to an embodiment. The computer system 100 includes at least one host device 101 having at least a User Interface (UI) 107. The computer system 100 also includes a stylus management platform 103; at least one application provider device 109; and at least one stylus device 111. An application provider device 109 can be operatively coupled to one or more host devices 101, one or more stylus devices 111, and/or other application provider devices 109 via a communication network 105. Note that the stylus management platform 103 or some of its components can be embedded within the host device 101, embedded within an application provider device 109, embedded within a stylus device 111, and/or be external to the host device 101, the application provider device 109, and the stylus device 111. In addition, the stylus management platform 103 can be operatively coupled to one or more host devices 101, one or more application provider devices 109, or one or more stylus device 111 via a communication network 105. Any of the devices or platforms of the computer system 100 can be equipped with local memory/storage spaces and/or processors (not shown in FIG. 1). Furthermore, the devices and platforms of the computer system 100 may have access to centralized or distributed memory/storage spaces and/or processors (not shown in FIG. 1) through the communication network 105. Thus, FIG. 1 is merely an example illustrating the types of devices and platforms that can be included within a computer system 100.

Communication network 105 can be any communication network, such as the Internet, configurable to allow the host device 101, the stylus management platform 103, the application provider device 109, and the stylus device 111 to communicate with communication network 105 and/or to each other through communication network 105. Communication network 105 can be any network or combination of networks capable of transmitting information (e.g., data and/or signals) and can include, for example, a telephone network, an Ethernet network, a fiber-optic network, a wireless network, and/or a cellular network.

In some instances, communication network 105 can include multiple networks operatively coupled to one another by, for example, network bridges, routers, switches and/or gateways. For example, the host device 101 and/or the stylus device 111 can be operatively coupled to a cellular network; the application provider device 109 and/or the stylus management platform 103 can be operatively coupled to a fiber-optic network. The cellular network and fiber-optic network can each be operatively coupled to one another via one or more network bridges, routers, switches, and/or gateways such that the cellular network, the Ethernet network and the fiber-optic network are operatively coupled to form a communication network. Alternatively, the cellular network and fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communication network.

As illustrated in FIG. 1, the host device 101 is operatively coupled to communication network 105 via network connection(s) 113; application provider device 109 is operatively coupled to communication network 105 via network connection(s) 115; and the stylus management platform 103 is operatively coupled to communication network 105 via network connection(s) 117. Network connections 113, 115 and 117 can be any appropriate network connection for operatively coupling host device 101, application provider device 109, and the stylus management platform 103, respectively. In addition, the stylus device 111 can be directly coupled to a host device 101 via connection(s) 121. A connection 121 can, for example, be provided via a wireless connection, such as, for example, a Bluetooth® connection, a ZigBee® connection, Near Field Communication (NFC), etc. In some instances, the stylus device 111 can be operatively coupled to communication network 105 via network connection(s) 119.

A network connection can be a wireless network connection such as, for example, a wireless fidelity (“Wi-Fi”) or Wireless Local Area Network (“WLAN”) connection, a Wireless Wide Area Network (“WWAN”) connection, and/or a cellular connection. A network connection can be a wired connection such as, for example, an Ethernet connection, a Digital Subscription Line (“DSL”) connection, a broadband coaxial connection, and/or a fiber-optic connection.

As mentioned above, in some instances, a computer system 100 can include more than one host device 101, more than one stylus management platform 103, more than one application provider device 109, and more than one stylus devices 111. A host device 101, a stylus management platform 103, an application provider device 109 and/or a stylus devices 111, can be operatively coupled to the communication network 105 by heterogeneous network connections. For example, a first host device 101 can be operatively coupled to the communication network 105 by a WWAN network connection, another host device 101 can be operatively coupled to the communication network 105 by a DSL network connection, and a stylus management platform 103 can be operatively coupled to the communication network 105 by a fiber-optic network connection. The application provider device 109 can be, for example, a web server configured to provide various applications to electronic devices, such as host device 101.

The host device 101 can be any of a variety of electronic devices that can be operatively coupled to communication network 105. A host device 101 can be a personal computer, a tablet computer, a personal digital assistant (PDA), a cellular telephone, a portable/mobile internet device and/or some other electronic communication device. The host device 101 can include a web browser configured to access a webpage or website hosted on or accessible via the application provider device 109 over communication network 105. The host device 101 can be configured to support, for example, HTML using JavaScript. For example, the host device 101 can include a web browser, such as, Internet Explorer®, Firefox®, Safari®, Dolphin®, Opera® and Chrome®, etc. An Internet page or website can be accessed by a user of a web browser at a host device 101 by providing the web browser with a reference such as a uniform resource locator (URL), for example, of a webpage.

In some instances, a user of a host device 101 can access an application provider device 109, using a stylus device 111, via a URL designated for the application provider device 109. The host device 101 can access an application provided by the application provider device 109 via the URL. In some instances, the user can download an application from the application provider device 109 and the stylus device 111 can operate the application locally. In some instances, a host device 101 can include specialized software for accessing a web server other than a browser, such as, for example, a specialized network-enabled application or program. In some instances, portions of a website accessible via a web server can be located in a local or remote memory space/data store accessible to the web server. A data store can be at least one of a database, a data warehouse, or a file. In other instances, software stored locally on the host device 101 (e.g., in a memory) can be operable to perform the functions described herein with reference to the application provider device 109. A host device 101 can also include a display device (e.g., a liquid crystal display device, a cathode ray tube device, etc.) operable to present a graphical user interface (GUI). The host device 101 can be a touch-enabled device, such that the display device can also be an input device. Similarly stated, the host device 101 can include a user interface (UI) 107 operable to output data to a user (e.g., via a GUI) and/or receive touch-based inputs. The host device 101 can also include, for example, a keyboard, various ports (e.g., a USB port), and other user interface features, such as, for example, digital pens, mice, touch screen controls, audio components, and/or video components (each not shown). A host device 101 can be operatively coupled to communication network 105 via the UI 107 and network connection 113.

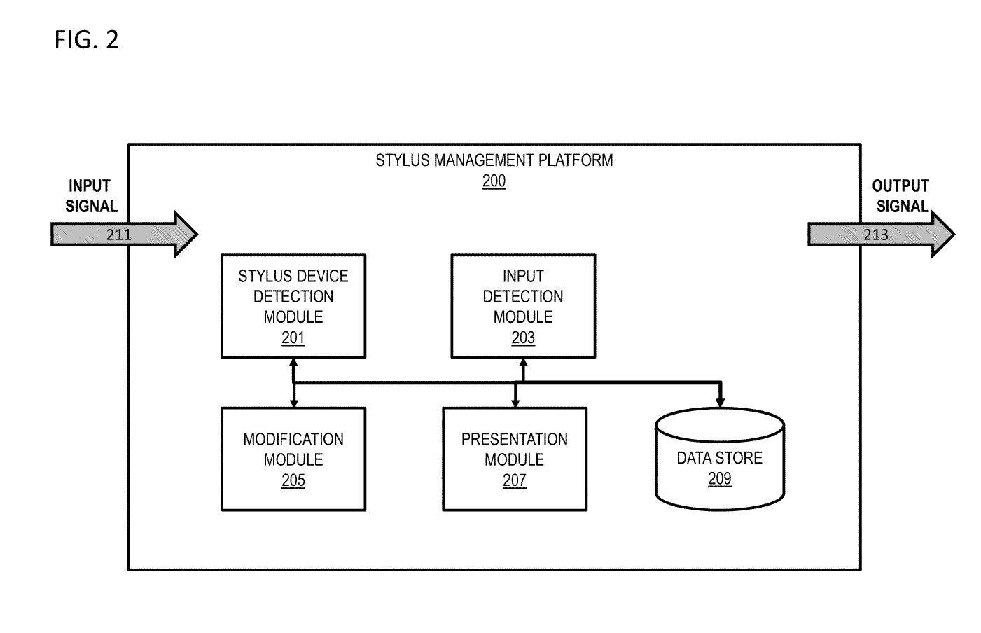

FIG. 2 is a schematic illustration of a stylus management platform 103 of FIG. 1, according to an embodiment. Stylus management platform 200 of FIG. 2 can be similar to the stylus management platform 103 of FIG. 1. As shown in FIG. 2, a stylus management platform 200 can include a stylus device detection module 201, an input detection module 203, a modification module 205, a presentation module 207, and a data store 209. Furthermore, the stylus management platform 200 can communicate with other components of a computer system (e.g., computer system 100 of FIG. 1) via input signal 211 and output signal 213, which are received and sent respectively through an input port and an output port (not shown in FIG. 2).

In various instances, the stylus management platform 200 and its components may be located anywhere within a computer system 100 such as that shown in FIG. 1 including, but not limited to, within the host device 101, within the application provider device 109, within the stylus device 111, or in separate locations within the computer system 100 of FIG. 1.

As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the stylus management platform 200, as discussed further below. The stylus management platform 200 can provide management of at least one stylus device 111 on a host device 101 with a UI 107.

In some instances, the stylus device detection module 201 can recognize a stylus device 111 at least based on an identification number, a serial number, a type, a version, etc. For example, a user of the host device 101 can register one or more stylus devices 111 at the stylus management platform 200 via a host device 101. The stylus management platform 200 can store data associated with stylus device registrations in data store 209. The stylus device detection module 201 can use the registration data from the data store 209 to identify each stylus device 111. For example, the stylus device detection module 201 can receive one or more signals representing a current status of the stylus device 111 via an input signal 211. The stylus detection module 201 can be operable to use the input signal 211 to, for example, detect which of several stylus devices are active, and/or which tip portion of a dual-tipped stylus device is active.

In some instances, the input detection module 203 can receive one or more signals representing various interactions between a user of a host device 101 and the stylus device 111, via an input signal 211. The input detection module 203 can use the input signal to detect interactions between a stylus device 111 and the UI 107 based on interactions between the user, the UI 107 and the stylus device 111. The interactions can include, for example, input by the user of stylus device 111 such as, for example, turning the stylus or touching the screen of UI 107 (e.g., a “touch event”). The interaction can also include selection of various functions and/or tools provided by the stylus device 111 by the user. The input detection module 203 can store data associated with the detection in data store 209.

In some instances, the input detection module 203 can recognize orientation and position of the stylus device 111, pressure applied to stylus device 111 against a UI 107 of host device 101, a spot size of a contact patch formed between a tip of stylus device 111 and the UI 107, etc. The input detection module 203 can, for example, detect whether a stylus device 111 is tilted or is laid flat on the screen on UI 107. The input detection module 203 can also be operable to the direction of movement of the stylus device 111 against the screen of UI 107. In some instances, the input detection module 203 can be operable to detect an angle between the stylus device 111 and the screen of the UI, for example, based on a size and/or shape of a contact patch between the stylus device 111 and the screen of UI and/or any other suitable means. The input detection module 203 can store data associated with the detection in data store 209. In some instances, the input detection module 203 and the stylus device detection module 201 can collectively be operable to detect the location, orientation, movement, etc. of the stylus device.

In some embodiments, signals received by the input detection module 203 and/or the device detection module can include time data (e.g., a time stamp) and/or the input detection module 203 and/or the device detection module can be operable to determine the time at which a signal is received. In this way, the stylus management platform 200 (e.g., the modification module 205) can be operable to compare the time at which a touch event and a signal associated with a stylus device being active occur. This can enable the stylus management platform 200 to determine the sequence of touch events and stylus device activations, such that, for example, touch events occurring after receiving an indication of an end of a stylus being activated are associated with that end of the stylus.

In some instances, the modification module 205 can receive output from the stylus device detection module 201 and/or from the input detection module 203 to execute functions and processes for applying user input on a content displayed on the screen of UI 107. The content can be a sketch, a drawing, a writing, an image, a menu containing various options to be selected, etc. For example, an input by a user of stylus device 111 (detected by the input detection module 203) combined with a specific orientation of the stylus device 111 can be used by the modification module 205 to define a width of a stroke by the stylus device 111 on the screen of UI 107. Similarly, an input by the user combined with another specific orientation (e.g., a gradient against the screen) of the stylus device can be used to define the type of the stroke.

In some instances, the modification module 205 can apply modifications by the user on the contents of the screen, based on output from the stylus device detection module 201 and/or from the input detection module 203. The modification module 205 can apply the modifications indicated by the input on the contents of selected portion of the screen, but not on other portions of the screen (e.g., portions of the screen outside of a selected portion).

For example, the modification module 205 can apply different modifications to the screen based on a combination of signals received from the stylus detection module 201 and/or the input detection module 203. In one instance, the stylus detection module 201 may not receive an indication of any stylus or any end portion of any stylus being activated when the input detection module 203 receives an indication of a touch event. This may occur, for example, if a user is interacting with the UI with a finger, rather than with a stylus. In such an instance, the modification module 205 can be operable to apply a first modification to the contents of the screen (e.g., select an object, draw a line, etc.). In another instance, the stylus detection module 201 may detect a writing portion of a stylus device being active when the input detection module 203 receives an indication of a touch event. This may occur, for example, when the writing tip (e.g., distal tip) of a stylus device touches or moves across the UI. In such an instance, as described in further detail herein, the modification module 205 can be operable to apply a second modification to the contents of the screen, such as illustrating a pencil line. In yet another instance, the stylus detection module 201 may detect an eraser portion of a stylus device being active when the input detection module 203 receives an indication of a touch event. This may occur, for example, when the eraser end (e.g., distal end) of a stylus device touches or moves across the UI. In such an instance, as described in further detail herein, the modification module 205 can be operable to apply a third modification to the contents of the screen, such as deleting (or subtracting) a portion of the image.

In some instances, the presentation module 207 provides a presentation of the modifications performed by the modification module 205 on the screen of UI 107 of the host device 101 via an output signal 213. In various instances, the stylus device detection module 201, the input detection module 203, the modification module 205, and the presentation module 207 can store data associated with the stylus device status and/or orientation, user input, modifications, functions applied to the screen content, etc., in data store 209.

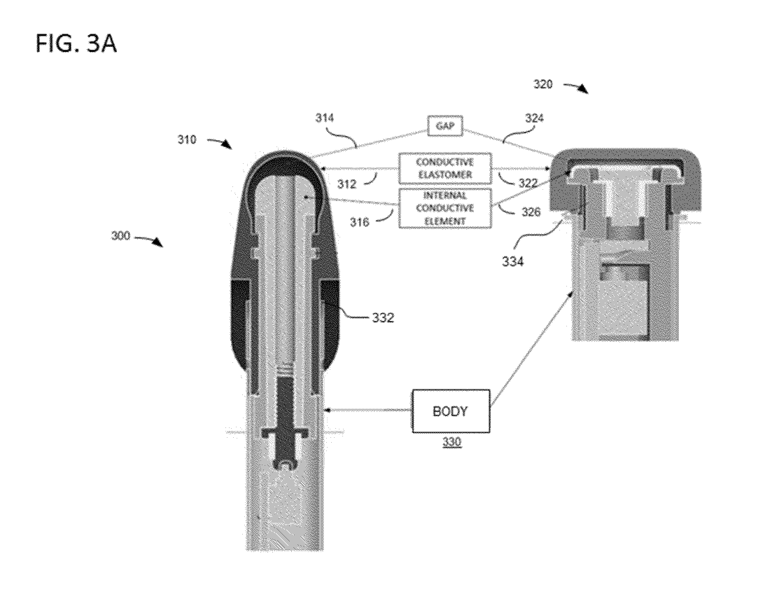

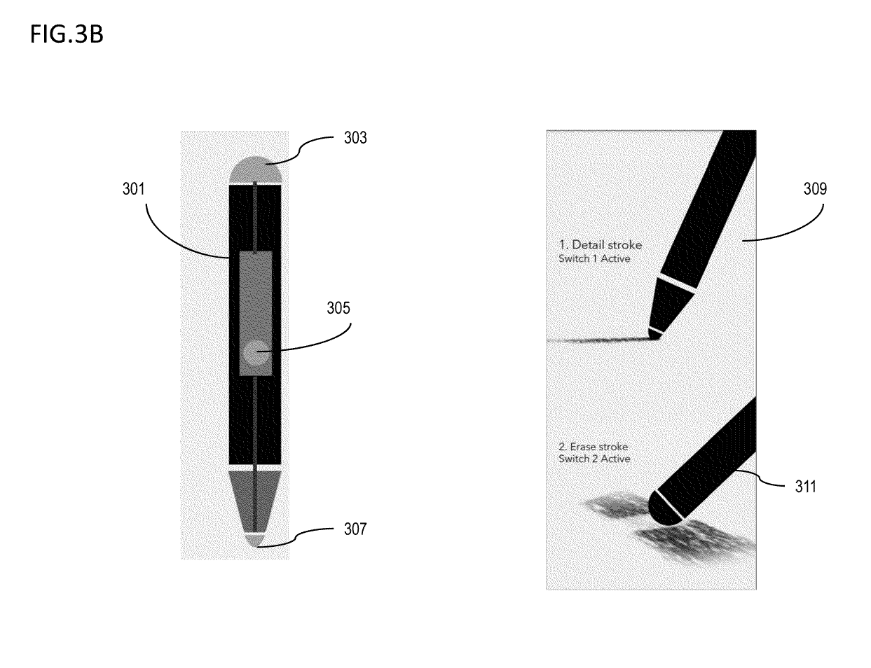

FIG. 3A is a cross sectional view of a stylus device 300, according to an embodiment. The stylus device 300 has a distal end portion 310 and a proximal end portion 320. The distal end portion 310 has a shaped similar to a marking end of a pencil or other writing implement. The proximal end portion 320 has a shape similar to an erasing end of a pencil.

The stylus device 300 can be operable to be used with a variety of different host devices manufactured by different manufacturers such as, for example, the Apple iPad®, the Samsung ATIV Smart PC®, the Samsung Galaxy®, the Amazon Kindle Fire®, the Toshiba Excite®, and/or the like. Hence, prior to usage, the stylus device 300 can first establish a communication link between the stylus device and the host device (e.g., electronic tablet). Similarly stated, the stylus device can pair with the host device. In some configurations, a communication link can be established between the stylus device 300 and the host device by sending a set of wireless configuration setup signals from the wireless transceiver of the stylus device 300 to the host device and receiving a set of wireless confirmation signals from the host device at the wireless transceiver of the stylus device 300. For example, the stylus detection module 201, as shown and described above with reference to FIG. 2 can be operable to allow the host device receive signals from the stylus device 300. The wireless transceiver of the stylus device 300 can connect with the host device using any wireless communication technology such as, for example, Institute of Electrical and Electronics Engineers (IEEE) 802.11x Wi-Fi®, Bluetooth®, or other wireless communication technology. Upon establishing successful communication between the stylus device 300 and the host device, the stylus device 300 can be ready to be used by the user.

Each end portion 310, 320 of the stylus device 300 includes an external conductive surface (also referred to herein as an external conductive element, external conductive member or tip member) 312, 322 made of, for example, an elastomer (e.g., rubber) and an internal conductive element (or member) 316, 326. The external conductive surface 312, 322 is external to the internal conductive element 316, 326. In some embodiments, the external conductive surface 312, 322 can be partially and/or entirely external to a body 330 or case of the stylus device 300. In some embodiments, the internal conductive element 316, 326 can be partially and/or entirely internal to the body 330 of the stylus device. As shown, the gap 314 of the distal end portion 310 of the stylus device 300 is entirely distal of a distal end 332 of the body 330 of the stylus device 300. Similarly, as shown, the gap 324 of the proximal end portion 320 of the stylus device 300 is be entirely proximal of a proximal end 334 of the body 330 of the stylus device 300.

The external conductive surfaces 312, 322 can be movable and/or deformable relative to the rest of the stylus device 300 and/or the internal conductive elements 312, 322. In some embodiments, the internal conductive element 316, 326 can be stationary relative to the rest of the stylus device 300. Each of the external conductive surfaces 312, 322 and each of the internal conductive elements 316, 326 can be connected to separate signal lines in the circuit. In some embodiments, the external conductive surfaces 312, 322 are coupled to the ground of the stylus device 200, 300. In some embodiment, the body 330 of the stylus device 200, 300 can be the ground, for example in embodiments where the case is constructed of a conductive material. In other embodiments, an internal shield can be the ground.

In some embodiments, the stylus device 300 can include a dielectric layer, which can prevent the internal conductive element 316, 326 from being connected to the ground when the respective end portion of the stylus device 200, 300 is not in use. When an end portion of the stylus device 200, 300 is not in contact with the surface of the host device, the external conductive surface 312, 322 is not in physical or electrical contact with the corresponding internal conductive element 316, 326. Hence, the electrical circuit for that end portion is an open circuit and the switch for that end portion in the open or “passive” configuration.

The external conductive element 312, 322 can be made of an elastomer material. In such embodiments, when force is applied to the external conductive element 312, 322 for a given end portion when that end portion is in contact with the host device surface, for example, during writing or drawing or erasing, the external conductive element 312, 322 can deform (i.e., change configuration, for example, from an unbiased configuration to a biased configuration) and move into physical and electrical contact with the internal conductive element 316, 326. Similarly stated, the external conductive element 312, 322 can deform to close the gap 314, 324. Thus, when the external conductive element 312, 322 deforms more than a threshold amount (e.g., an amount sufficient to close the gap 314, 324 when, for example, a threshold force is applied), the external conductive element 312, 322 can move into physical and/or electrical contact with the internal conductive element 316, 326. This produces a closed circuit that can allow current to flow from a voltage source (not shown). The voltage source can be for example, an AAA battery, a lithium polymer battery, a solar panel voltage source, and/or the like. In some embodiments, elastic deformation of the external conductive element 312, 322 can close the circuit (e.g., move a switch into a closed configuration) without other moving parts.

When an end portion 310, 320 of the stylus device 300 is actuated, a switch associated with that end portion can be moved to a closed configuration. The activated switch can be detected by a processor of the stylus device 310 that can cause a wireless signal to be sent, for example, via a wireless transceiver to the host device that identifies the “active” end portion of the stylus device 300. Such a signal can be detected by a stylus detection module. In the opposite end portion of the stylus device (not in contact with the host device surface), the switch remains in the “open” configuration and no electrical contact exists between the external conductive surface and the internal conductive element. The processor can similarly detect the “open” configuration. Thus, the processor can be operable to distinguish which end portion of the stylus device is in contact with the host device surface (e.g., electronic tablet surface) and can thus enable multi-tip functionality (e.g., writing/drawing tip and erasing).

In some instances, when the external conductive element 312, 322 is moved (e.g., deformed and/or moved into a biased configuration) into contact with the internal conductive element 316, 326, the processor can be operable to measure or determine a pressure. For example, the internal conductive element 316, 326, and/or the external conductive element 312, 322 can be operable to modulate the voltage passed via the switch to the processor. Similarly stated, the switch can be operable to enable resistance sensing. The stylus device 300 can transmit a signal associated with the pressure, which can be received by a stylus detection module and/or an input detection module of the host device. The measured or determined pressure can be used to adjust a displayed line thickness, darkness, etc.

FIG. 3B is an illustration of a stylus device, according to an embodiment. The stylus device 301 is similar to the stylus device 111 of FIG. 1. In some instances, the stylus device 301 has two end portions 303 and 307. The end portion 303 is equipped with an end cap conductive elastomer and the tip portion 307 is equipped with a tip conductive elastomer. The stylus device 301 can also have a wireless transceiver 305 that can identify the end portion of the stylus device 301 in contact with an object such as, for example, with the screen of a host device (UI 107 of host device 101 in FIG. 1, not shown in FIG. 3B).

In some instances, the wireless transceiver 305 can enable the stylus device 301 to communicate with a host device (101 in FIG. 1, not shown in FIG. 3B) when a user is entering a stylus-based input (e.g., drawing strokes using the stylus device 301) with an end portion 303 or a tip portion 307 on a screen of UI 107. Such functionality can provide the stylus device 301 with a wide range of functions for applications associated with the host device 101. For example, a user can use the stylus device 301 to draw with tip portion 307, shown as 309, and then flip the stylus device 301 to erase with end portion 303, shown as 311, similar to drawing with a pencil on paper. As another example, the stylus device 301 can have a marker color functionality on one side (e.g., tip portion 307) and a color blend functionality on the other side (e.g., end portion 303).

In some instances, the stylus device 301 can provide universal functionalities to a host device 101 regardless of the type and/or configuration of the host device 101. The stylus device 301 can provide such functionalities without using a brush setting on a menu on UI 107 or without a button on the stylus device 301 for the user to press to modify a tool or a functionality. In such instances, the user is enabled to naturally flip the stylus device 301 for added functionality. This can increase ease of use, workflow fluidity, and efficiency for applications on a host device 101 that can work with a stylus device 301.

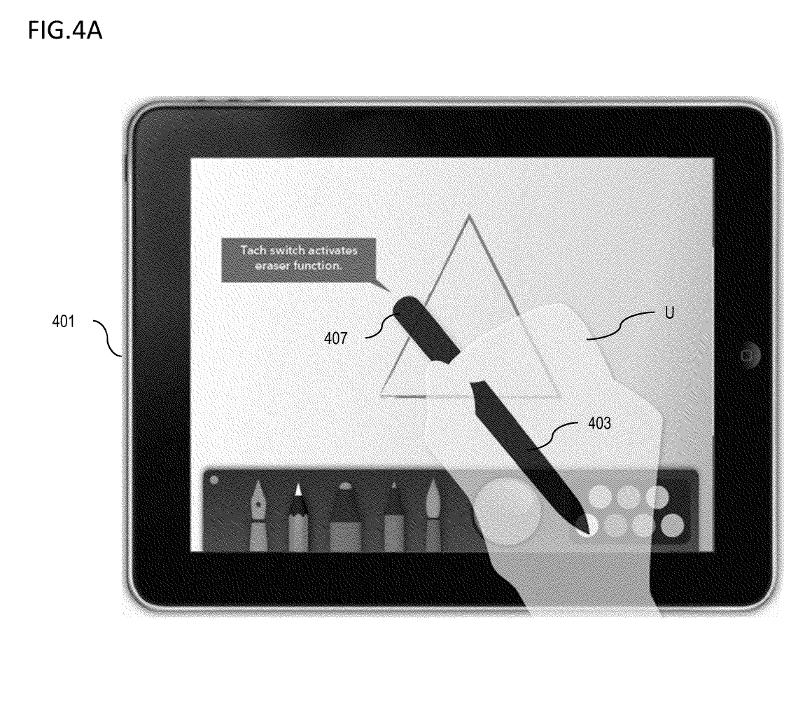

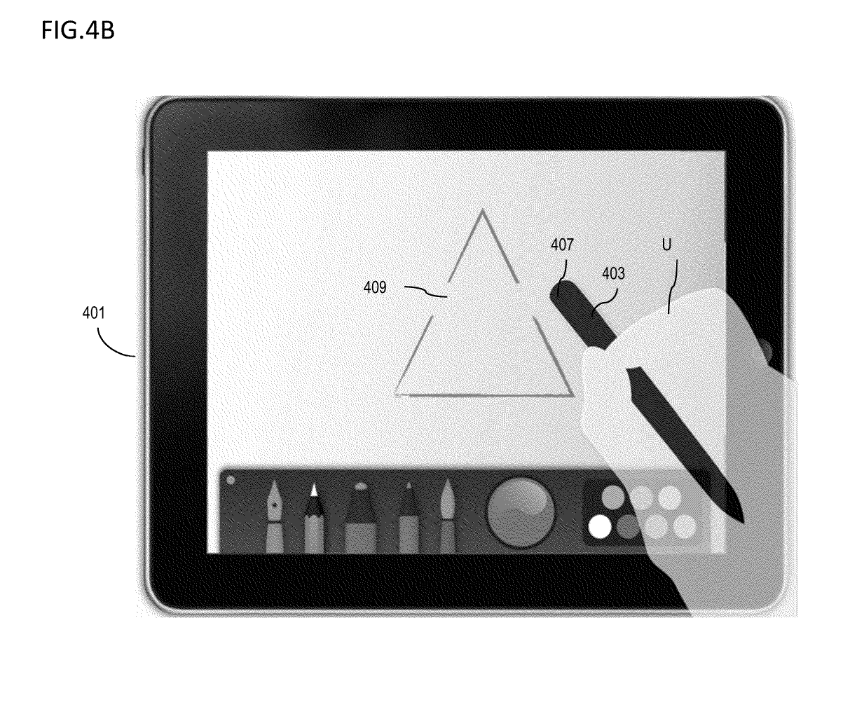

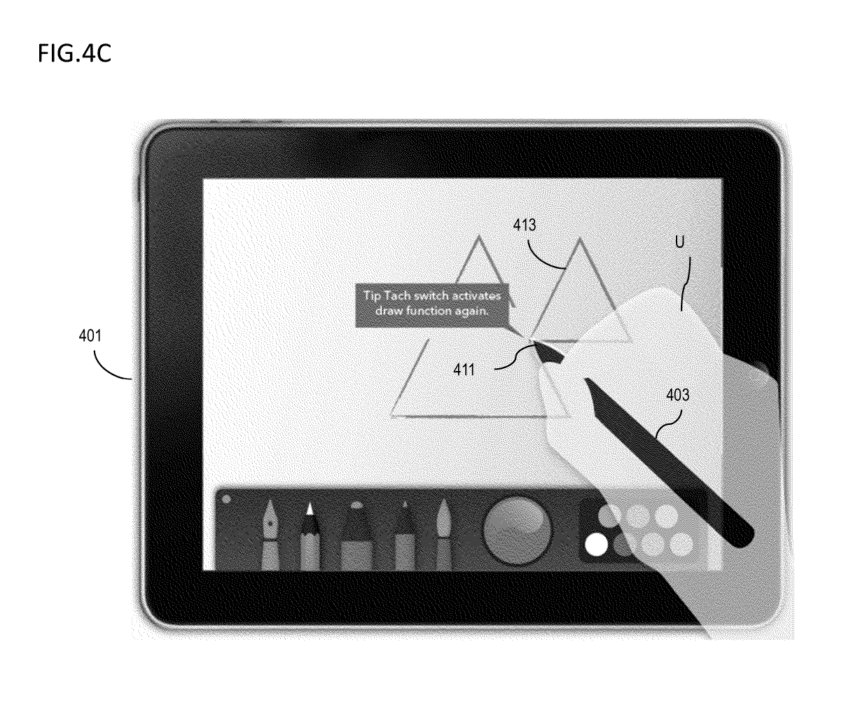

In various instances, different functionalities of a stylus device 301 can be activated by a user of the stylus device (not shown) via, for example, selecting a function from a menu on a screen of a UI of a host device (shown as UI 107 and host device 101 in FIG. 1), pushing a button on the stylus device 301 (not shown), tapping on a specific area(s) of the surface of the UI screen while an indicator on the stylus device 301 changes and/or an indicator on the UI screen changes, etc. Various functionalities of the stylus device 301 are described further below with regards to FIGS. 4-10.

FIGS. 4A-4C are sample illustrations of flip-to-erase functionality of a stylus device, according to an embodiment. In some instances, when a stylus device 403 is held by a user U against a screen 401 of a host device, the stylus device 403 can actuate the end portion 407 as an eraser. The screen 401 is similar to the UI 107 of FIG. 1 and the stylus device 403 is similar to the stylus device 111 of FIG. 1. As seen in FIG. 4B, when user U moves the end portion 407 of the stylus device 403 against the screen 401, parts of the triangle 409 touched by the end portion 407 are erased. In FIG. 4C when user U flips the stylus device 403 to its tip portion 411, the stylus management platform 200 recognizes the tip portion 411 and enables the tip portion to draw as the user draws a shape 413.

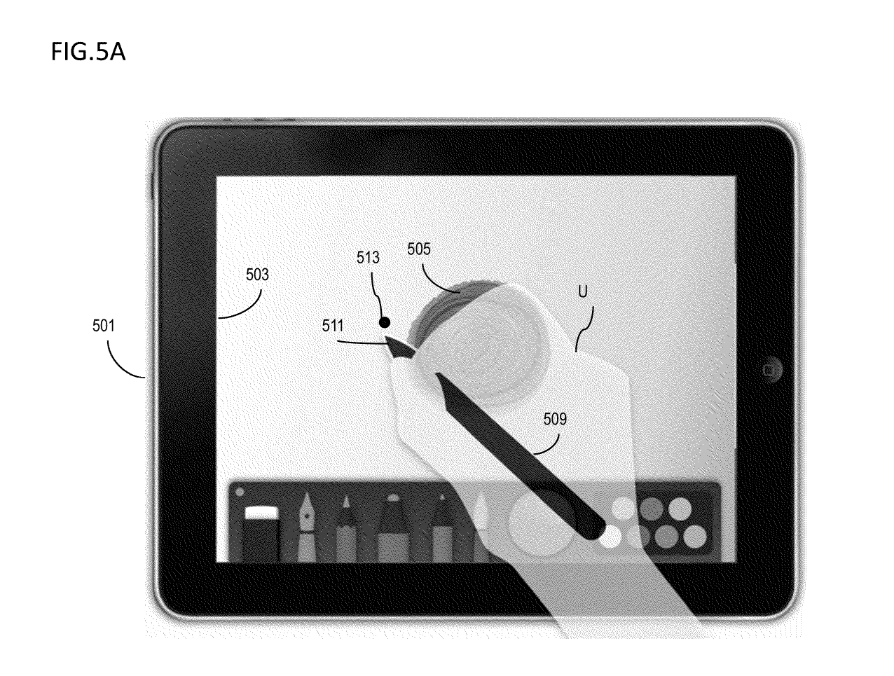

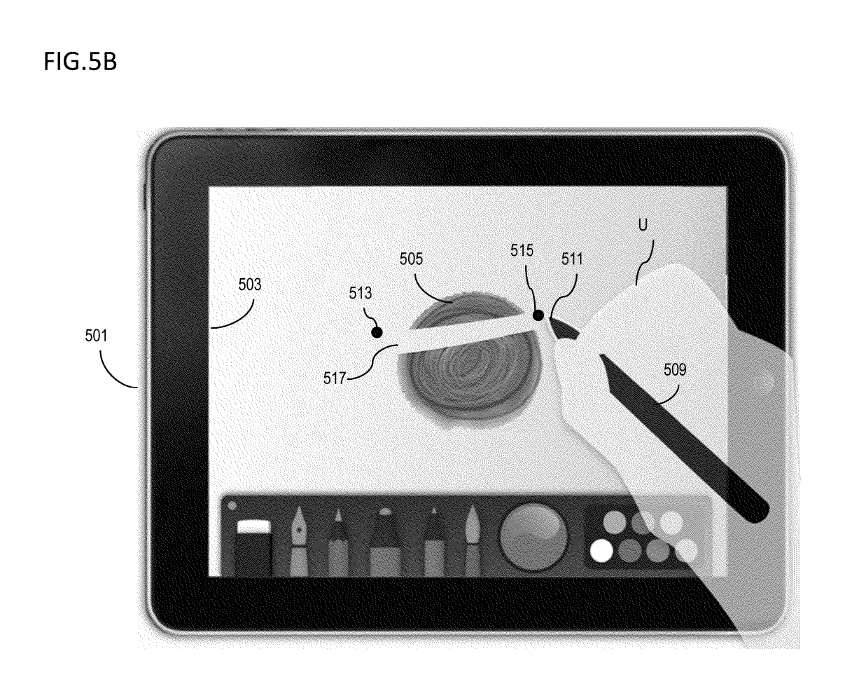

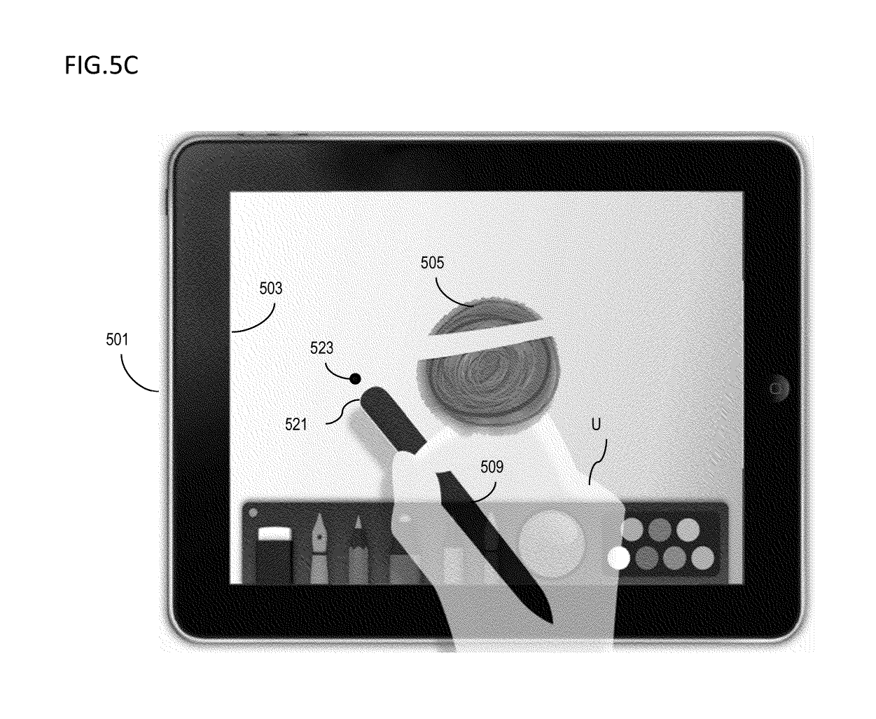

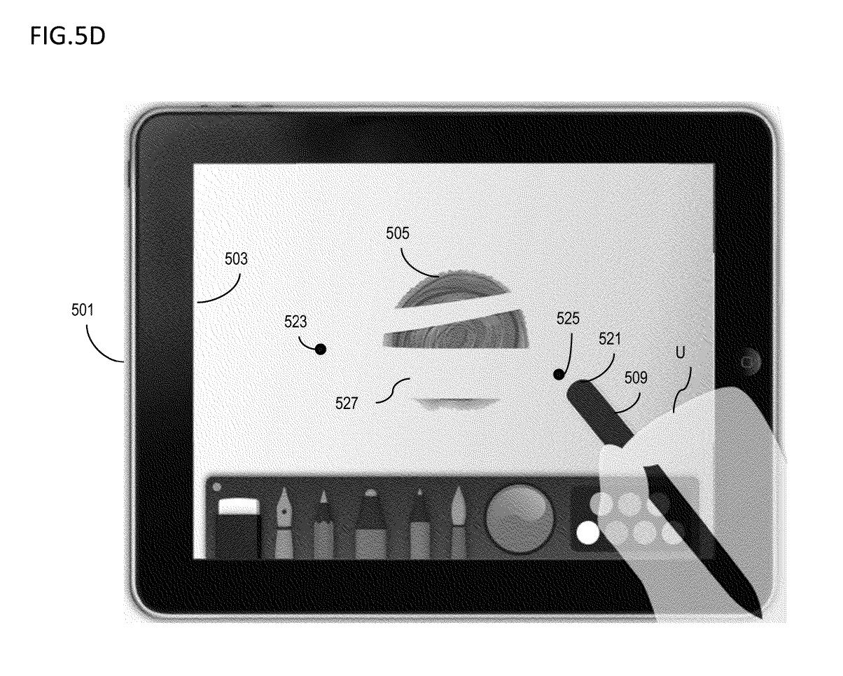

FIGS. 5A-5D are sample illustrations of flip-to-modify functionality of a stylus device, according to an embodiment. FIGS. 5A-5D depict multiple erase functionalities. FIG. 5A shows an object 505 on a screen 503 of a host device 501. The object 505 can be drawn by a user U using a stylus device 509, or downloaded or imported from a memory location of the host device 501, from other host devices 101 of FIG. 1, from an application provider device 109 of FIG. 1, from a network location accessed by the host device 501 via the communication network 105, etc. In some instances, the user U can activate the tip portion 511 and the end portion 521 as a thin eraser and a thick eraser, respectively. The user U can select the functionality via a menu, a button on the stylus device 403, a tap on screen 401, etc., as previously discussed. In such instances, the tip portion 511 of the stylus device 509 can function as a thin eraser. For example, a gesture by user U moving tip portion 511 of the stylus device 509 from position 513 shown in FIG. 5A to position 515 shown in FIG. 5B can actuate the tip portion 511 as an eraser to erase an area 517 of object 505.

In some instances, a gesture by user U flipping the stylus device 509 to end portion 521 can actuate the end portion 521 as a thick eraser. In such instances, when user U moves end portion 521 of the stylus device 509 from position 523 shown in FIG. 5C to position 525 shown in FIG. 5D can actuate the end portion 521 as a thick eraser to erase an area 527 of object 505.

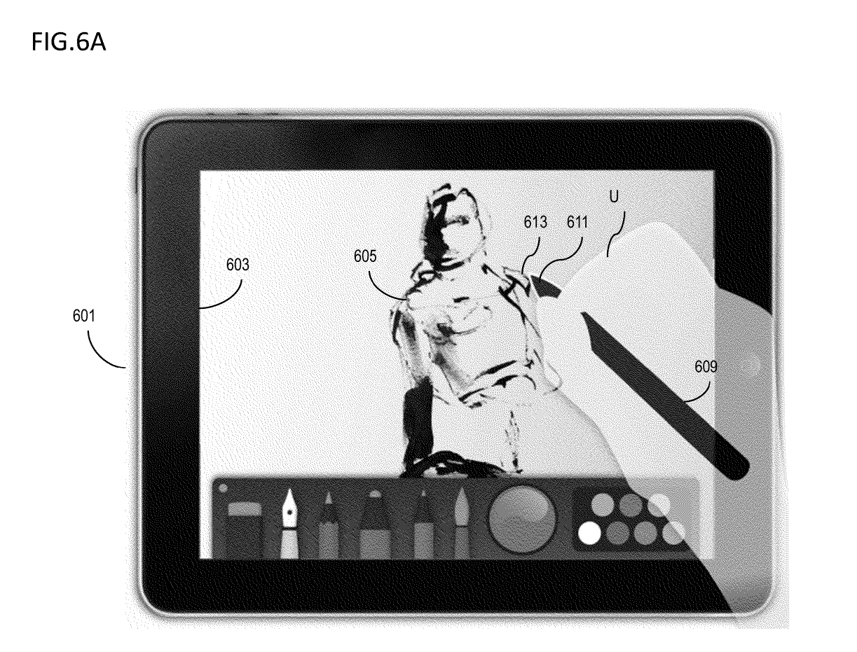

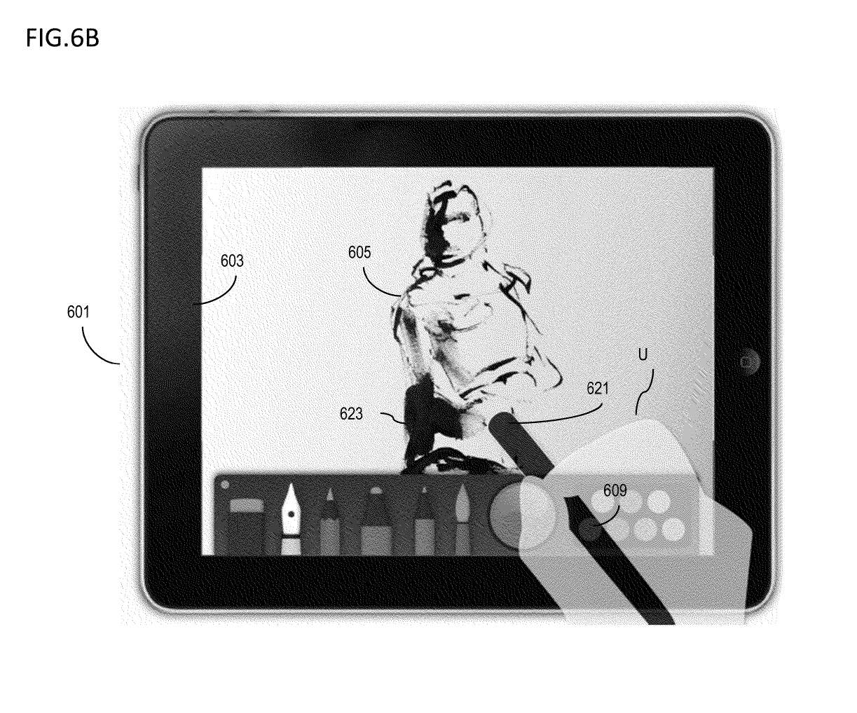

FIGS. 6A-6B are sample illustrations of ink-smear functionality of a stylus device, according to an embodiment. FIG. 6A shows an object 605 on a screen 603 of a host device 601. The object 605 can be drawn by a user U using a stylus device 609, or downloaded or imported from a memory location of the host device 601, from other host devices 101 of FIG. 1, from an application provider device 109 of FIG. 1, from a network location accessed by the host device 601 via the communication network 105, etc. In some instances, the tip portion 611 of the stylus device 609 can function as an ink tool drawing with a texture similar to drawings by ink on paper. For example, a gesture by user U moving tip portion 611 of the stylus device 609 can actuate the tip portion 611 as an ink tool and draw a context 613 on object 605.

In some instances, a gesture by user U flipping the stylus device 609 to end portion 621, shown in FIG. 6B can actuate the end portion 621 as an ink smear tool. In such instances, user U moving end portion 621 of the stylus device 609 against the screen 603 can actuate the end portion 621 as a tool for ink smearing, ink blowing, ink blotting, etc., to draw thick ink patches 623. While the user U's finger can be used as a switch (e.g., a third tip portion) touching/contacting or not touching/contacting the screen 603 of the host device 601, the stylus device 609 can distinguish the user U's finger from the tip portions 611 and 621. The stylus device 609 can also assign a function to the user U's finger. For example, the user U can be enabled to use his/her finger as a brush.

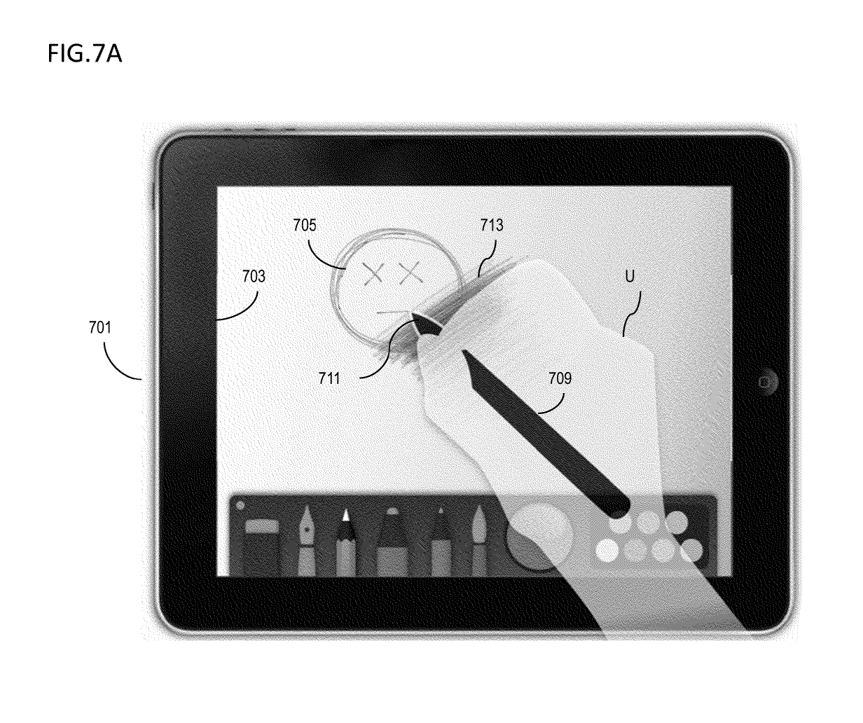

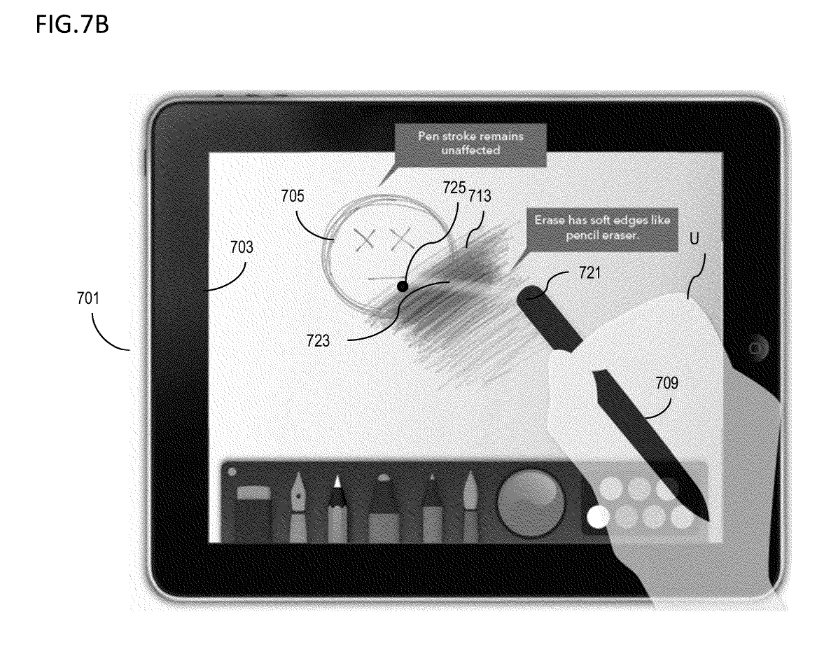

FIGS. 7A-7B are sample illustrations of pencil-effect functionality of a stylus device, according to an embodiment. FIG. 7A shows an object 705 on a screen 703 of a host device 701. The object 705 can be drawn by a user U using a stylus device 709, or downloaded or imported from a memory location of the host device 701, from other host devices 101 of FIG. 1, from an application provider device 109 of FIG. 1, from a network location accessed by the host device 701 via the communication network 105, etc. In some instances, the tip portion 711 of the stylus device 709 can function as a pencil, drawing with a texture similar to a pencil on paper. For example, user U can use stylus device 709 to draw a hatched area 713 on screen 703. The hatched area 713 may overlap object 705.

In some instances, a gesture by user U flipping the stylus device 709 to end portion 721, shown in FIG. 7B can actuate the end portion 721 as a soft eraser that erases content drawn by a pencil but not other content. In such instances, user U moving end portion 721 of the stylus device 709 against the screen 703 from position 725 to the location of end portion 721 as shown in FIG. 7B can actuate the end portion 721 as a soft eraser. The soft eraser 721 erases part of the hatched area 713 shown as 723 while does not affect the content of object 705 that was not drawn by a pencil effect.

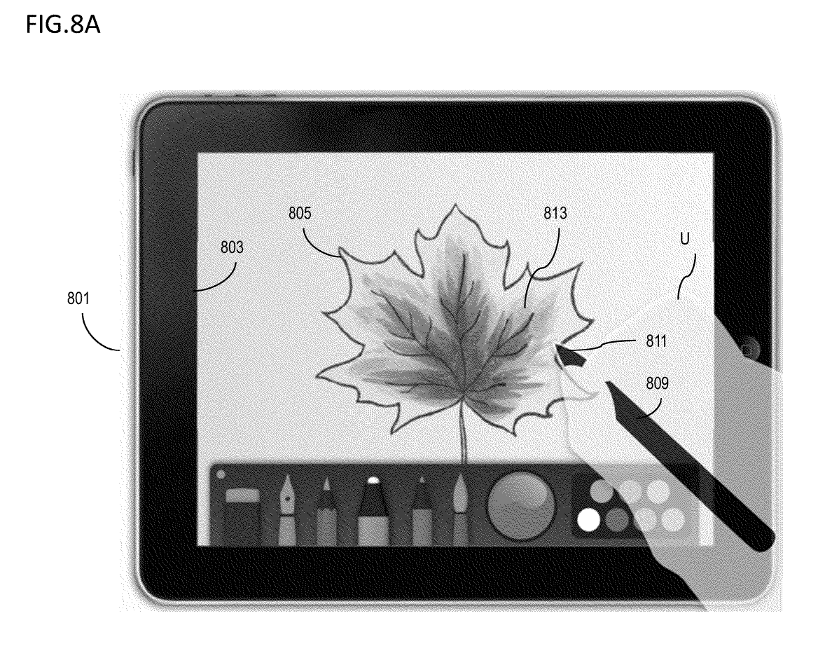

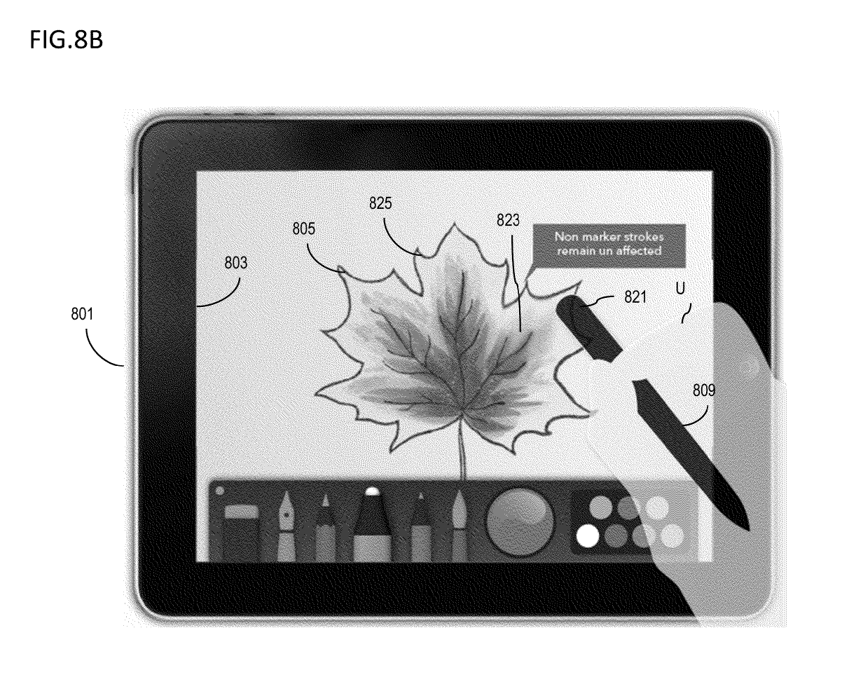

FIGS. 8A-8B are sample illustrations of marker-effect functionality of a stylus device, according to an embodiment. FIG. 8A shows an object 805 on a screen 803 of a host device 801. The object 805 can be drawn by a user U using a stylus device 809, or downloaded or imported from a memory location of the host device 801, from other host devices 101 of FIG. 1, from an application provider device 109 of FIG. 1, from a network location accessed by the host device 801 via the communication network 105, etc. In some instances, the tip portion 811 of the stylus device 809 can function as a marker, drawing with a texture similar to a marker on paper. For example, user U can use stylus device 809 to draw a hatched area 813 on screen 803. The hatched area 813 may overlap parts of object 805.

In some instances, a gesture by user U flipping the stylus device 809 to end portion 821, shown in FIG. 8B can actuate the end portion 821 as a marker blend tool that blends content drawn by a marker but not other content. In such instances, user U moving end portion 821 of the stylus device 809 against the screen 803 over the hatched area 823 of FIG. 8B can actuate the end portion 821 as a marker blend tool. The marker blend tool 821 blends the marker color of the hatched area 813 of FIG. 8A shown as 823 in FIG. 8B while does not affect the content of object 805 that was not drawn by a marker effect. Note that various functionalities such as, for example, blend functionality, can be defined and associated with various tools (e.g., eraser) and colors. For example, line 825 the border line of object 805 is not affected by the marker blend effect of end portion 821 of stylus device 809.

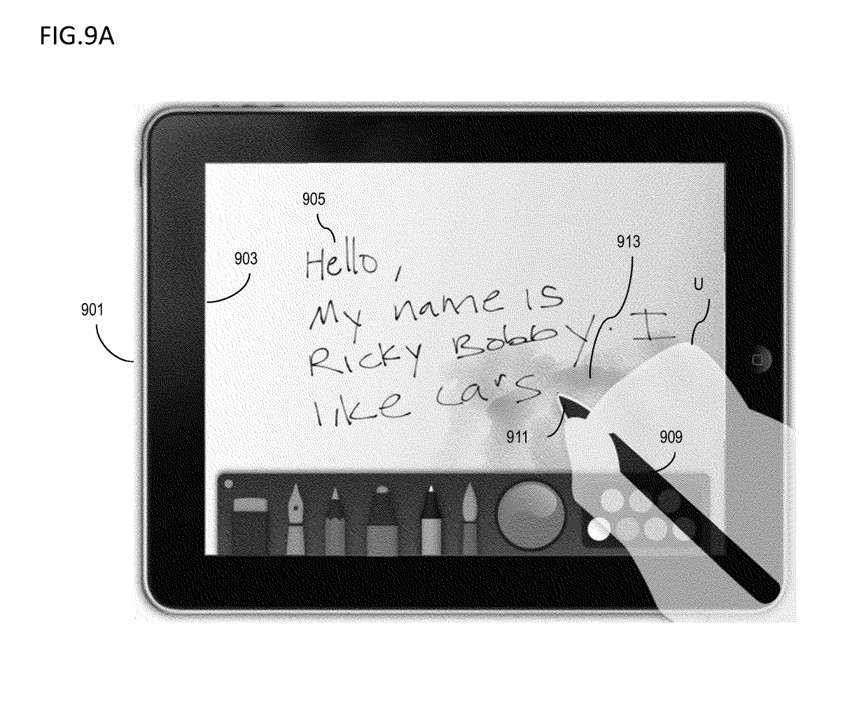

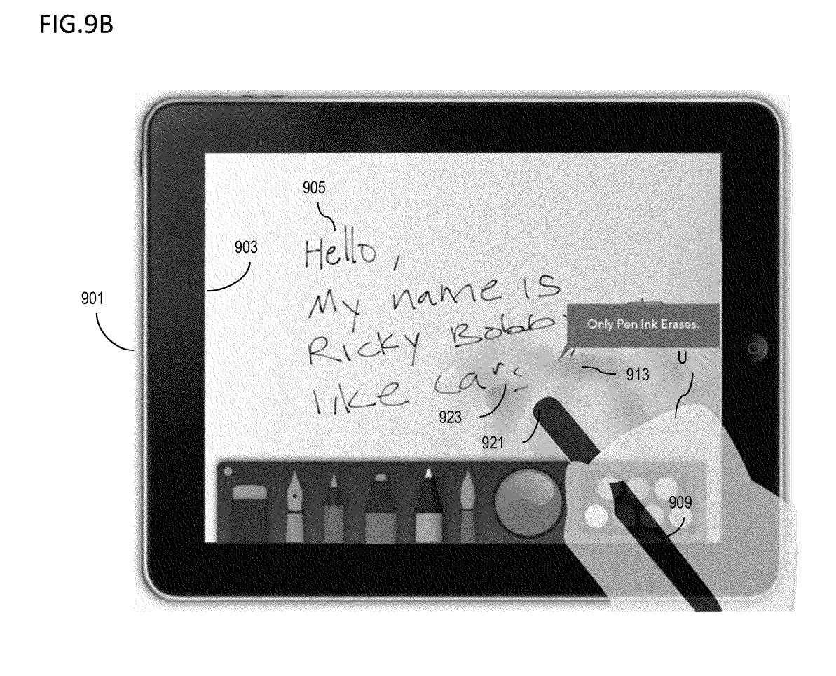

FIGS. 9A-9B are sample illustrations of pen-effect functionality of a stylus device, according to an embodiment. FIG. 9A shows a writing object 905 on a screen 903 of a host device 901. The writing 905 can be written by a user U using a stylus device 909, or downloaded or imported from a memory location of the host device 901, from other host devices 101 of FIG. 1, from an application provider device 109 of FIG. 1, from a network location accessed by the host device 901 via the communication network 105, etc. In some instances, the tip portion 911 of the stylus device 909 can function as a pen, writing with a texture similar to a pen on paper. For example, user U can use stylus device 909 to write a text 905 on screen 903. The background of writing 905 on screen 903 may include other contents such as for example the colored area shown as 913 in FIG. 9A.

In some instances, a gesture by user U flipping the stylus device 909 to end portion 921, shown in FIG. 9B can actuate the end portion 921 as a hard eraser that erases content drawn by a pen but not other content. In such instances, user U moving end portion 921 of the stylus device 909 against the screen 903 over the text 905 of FIG. 8B can actuate the end portion 921 as a hard eraser. The hard eraser 921 erases the written text 905 shown as 923 in FIG. 8B while does not affect the content of background that was not drawn by a pen effect. For example, the background color 913 is not affected by the eraser effect of end portion 921 of stylus device 909.

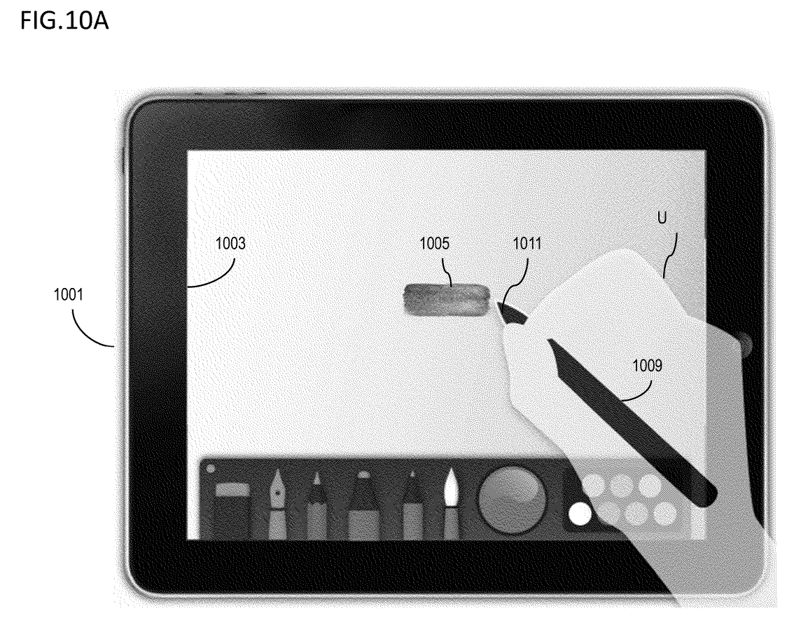

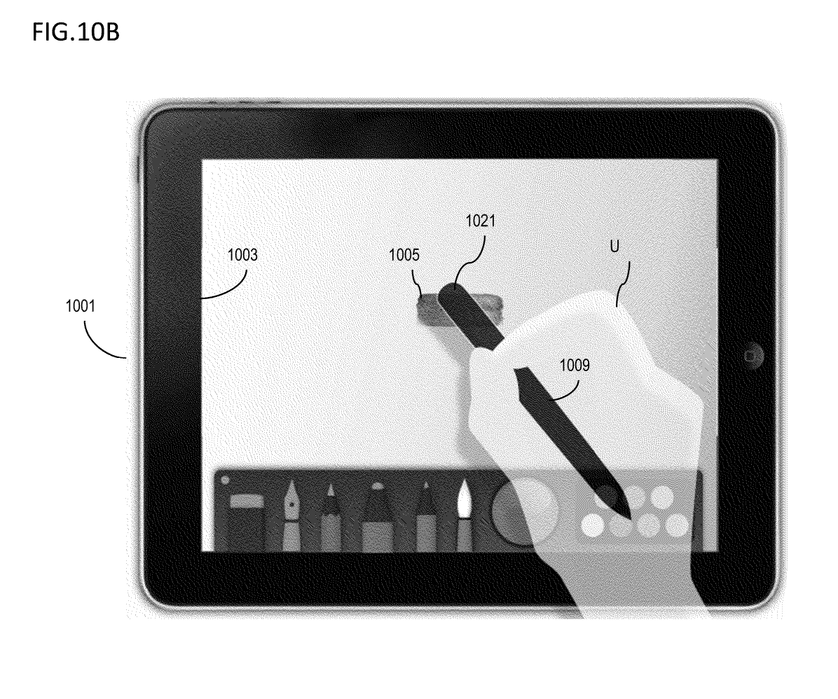

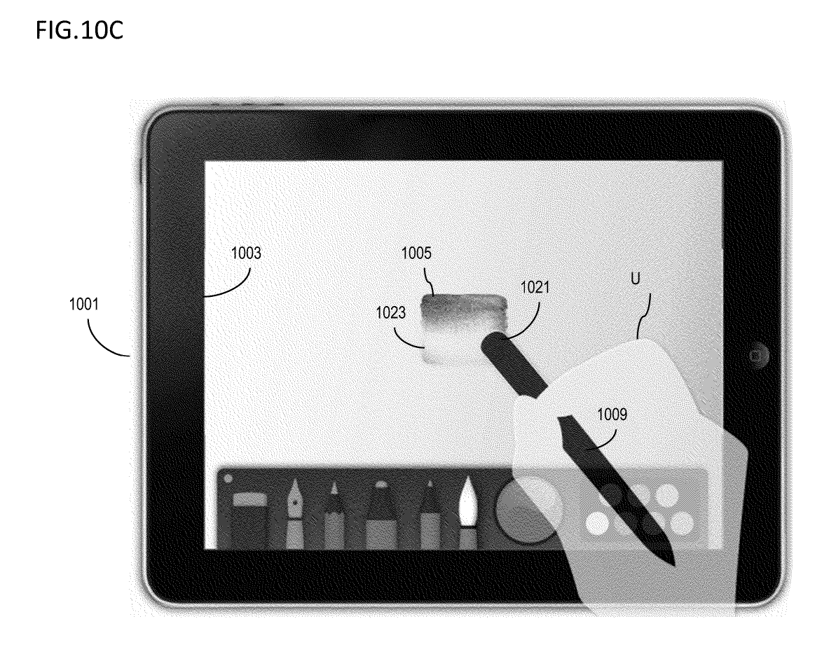

FIGS. 10A-10C are sample illustrations of wet-brush functionality of a stylus device, according to an embodiment. FIG. 10A shows a water color object 1005 on a screen 1003 of a host device 1001. The water color object 1005 can be drawn by a user U using a stylus device 1009, or downloaded or imported from a memory location of the host device 1001, from other host devices 101 of FIG. 1, from an application provider device 109 of FIG. 1, from a network location accessed by the host device 1001 via the communication network 105, etc. In some instances, the tip portion 1011 of the stylus device 1009 can function as a brush, drawing with a texture similar to a brush on paper. For example, user U can use stylus device 1009 to draw object 1005 on screen 1003.

In some instances, a gesture by user U flipping the stylus device 1009 to end portion 1021, shown in FIG. 10B can actuate the end portion 1021 as a wet brush that can wet wash colors of object 1005 or other colors selected by user U. In such instances, user U moving end portion 1021 of the stylus device 1009 against screen 1003 over the object 1005 of FIG. 10B can actuate the end portion 1021 as a wet brush. The wet brush 1021 can draw with water color effect when moved across screen 1003. As shown in FIG. 10C, when user U moves stylus 1009 across screen 1003, the end portion 1021 can draw with washed water color effect of object 1005 (shown as object 1023). In some instances, the wet brush effect of end portion 1021 can be defined as a blend of multiple colors from various objects on screen 1003 (not shown).

In some instances, the stylus device 1009 can monitor and measure its motion, for example, using an accelerometer disposed within the stylus device 1009. The accelerometer can send signals having acceleration information about the stylus device 1009 to the host device 1001 such that drawings functions can be implemented based on the acceleration information. In such instances, the stylus device 1009 can be used, for example, for drawing splattering paint effects, for example, to define abstract expressions.

It is intended that the methods and apparatus described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein.

For example, although some instances describe an input detection module detecting a touch event while a stylus detection module detects an active end portion of a stylus, and a modification module altering the contents of a GUI. In other instances, however, the modification module can be operable to alter the contents of the GUI according to a functionality associated with an end portion of a stylus even if stylus detection module does not detect that end portion of the stylus being active while the input detection module detects a touch event. For example, an end portion of a stylus can be registered, for example, by touching it to a registration portion of a UI and/or any other suitable means. Thereafter, the modification module can be operable to apply alterations to the GUI associated with that end portion of the stylus device, for example, until another registration is detected. For example, if, at a later time, a second end portion of the stylus is detected to be active, a touch event can be associated with the second end portion of the stylus and the modification module can alter the GUI accordingly.

What is claimed is:

1. A non-transitory processor readable medium storing code representing instructions to be executed by a processor, the code comprising code to cause the processor to:
receive a signal representing a first touch event;
receive a signal representing a first end portion of a stylus device being activated in response to an elastomeric external member being moved from an unbiased configuration to a biased configuration;
send a signal such that a mark is added to a graphical user interface based on the signal representing the first touch event and based on the processor having received the signal representing the first end portion of the stylus device being activated;
receive a signal representing a second touch event;
receive a signal representing a second end portion of the stylus device being activated; and
send a signal such that at least a portion of the mark is subtracted from the graphical user interface based on the signal associated with the second touch event and based on the processor having received the signal representing the second end portion of the stylus device being activated.

2. The non-transitory processor readable medium of claim 1, wherein the external elastomeric member is a first external elastomeric member, and the second end portion of the stylus device is activated when an elastomeric external member is moved from an unbiased configuration to a biased configuration.

3. The non-transitory processor readable medium of claim 1, wherein the signal based on the first end portion of a stylus device being activated is received wirelessly by a stylus device detection module operatively coupled to the processor.

4. The non-transitory processor readable medium of claim 1, wherein:
the signal based on the first end portion of a stylus device being activated is received wirelessly by a stylus device detection module electrically coupled to the processor; and
the signal based on the first touch event is received from an input module electrically coupled to the processor, the input module configured to detect physical contact with a surface of a host device.

5. The non-transitory processor readable medium of claim 1, wherein the code to cause the processor to send the signal such that the mark is added to the graphical user interface further includes code to cause the processor to send the signal such that the mark is added to the graphical user interface based on the processor not having received the signal representing a second end portion of the stylus device being activated before receiving the signal representing the first touch event.

6. The non-transitory processor readable medium of claim 1, wherein:
the signal representing the first touch event includes an indication of a time period associated with the first touch event;
the signal representing the second end portion of the stylus device being activated includes an indication of a time associated with the second end portion of the stylus device being activated; and
the code configured to cause the processor to send the signal such that the mark is added to the graphical user interface includes code to cause the processor to send the signal such that the mark is added to the graphical user interface only if the time associated with the second end portion of the stylus device being activated is after the time period associated with the first touch event.

7. The non-transitory processor readable medium of claim 1, wherein:
the signal representing the first touch event includes an indication of a time period associated with the first touch event;
the signal representing the first end portion of the of the stylus device being activated includes an indication of a time associated with the first end portion of the stylus device being activated; and
the code to cause the processor to send the signal such that the mark is added to the graphical user interface further includes code to cause the processor to send the signal such that the mark is added to the graphical user interface based the time associated with the first end portion of the stylus device being activated being within the time period associated with the first touch event.

8. A non-transitory processor readable medium storing code representing instructions to be executed by a processor, the code comprising code to cause the processor to:
receive, from a stylus device having two end portions, a signal representing a first end portion of the stylus device being activated when a gap between an external member and an internal conductive element being closed, the gap being entirely distal to a housing of the stylus device;
receive, from an input module, a first touch indication;
modify a graphical user interface according to a first functionality based on the processor having received the signal associated with the first end portion of the stylus device being activated and based on to the first touch indication;
receive, from the stylus device, a signal associated with the second end portion of the stylus device being activated;
receive, from the input module, a second touch indication; and
modify the graphical user interface according to a second functionality based on the processor having received the signal associated with the second end portion of the stylus device being activated and based on the second touch indication.

9. The non-transitory processor readable medium of claim 8, wherein:
the first functionality is adding a mark to the graphical user interface; and
the second functionality is removing at least a portion of the mark from the graphical user interface.

10. The non-transitory processor readable medium of claim 8, wherein:
the external member is a first external member, the internal conductive element is a first internal conductive element, and the gap is a first gap, and
the second end portion of the stylus device is activated when a second gap between a second external member and a second internal conductive element being closed, the second gap being entirely proximal to the housing of the stylus device.

11. The non-transitory processor readable medium of claim 8, wherein:
the graphical user interface is modified according to the first functionality at a first time, the graphical user interface is modified according to the second functionality at a second time after the first time, and
the code to cause the processor to modify the graphical user interface according to the second functionality includes code to cause the processor to modify the graphical user interface according to the second functionality without receiving an indication of a selection of the second functionality via the graphical user interface.

12. The non-transitory processor readable medium of claim 8, wherein:
the code to cause the processor to receive the first touch indication includes code to cause the processor to receive an indication of an orientation of the stylus device; and
the code to cause the processor to modify the graphical user interface according to the first functionality includes code to cause the processor to modify the graphical user interface based on the orientation of the stylus device.

13. The non-transitory processor readable medium of claim 12, wherein the orientation is a first orientation, the code further comprising code to cause the processor to:
receive, from the input module, a third touch indication including an indication of a second orientation of the stylus device; and
modify a graphical user interface according to a third functionality based on the signal representing the first end portion of the stylus device being activated and based on the third touch indication.

14. The non-transitory processor readable medium of claim 12, wherein the orientation is a first orientation, the first functionality is adding a mark having a first thickness to the graphical user interface, the code further comprising code to cause the processor to:
receive, from the input module, a third touch indication including an indication of a second orientation of the stylus device; and
modify a graphical user interface according to a third functionality based on the signal representing the first end portion of the stylus device being activated and based on the third touch indication, the third functionality being adding a mark having a second thickness to the graphical user interface.

15. The non-transitory processor readable medium of claim 8, wherein:
the external member is a conductive elastomeric member configured to deform, the gap being closed when the conductive elastomeric member deforms more than a threshold amount; and
the code to cause the processor to receive the first touch indication includes code to cause the processor to determine a force associated with the first touch indication based on a size of a contact patch between the conductive elastomeric member in a deformed configuration and a surface of a host device.

16. The non-transitory processor readable medium of claim 8, the code further comprising code to cause the processor to:
receive, from the input module, a third touch indication, the third touch indication being associated with a portion of a user's body contacting a surface of a host device;
determine that the third touch indication is not associated with the stylus device; and
modify the graphical user interface according to a third functionality based the determination that the third touch indication is not associated with the stylus device.

17. An apparatus, comprising:
an input module configured to detect a first touch event associated with a first end portion of a stylus device and a second touch event associated with a second end portion of the stylus device;
a communication module configured to receive a signal associated with a first end portion of the stylus device being activated, the communication module configured to receive a signal associated with a second end portion of the stylus being activated when a switch biased in an open configuration moves to a closed configuration when a tip member deforms;
a presentation module configured to cause a graphical user interface to be displayed via a display device; and
a modification module implemented in at least one of a processor or a memory, the modification module operatively coupled to the input module, the communication module, and the presentation module,
the modification module configured to send a signal to the presentation module to cause a first modification of the graphical user interface based on the input module detecting the first touch event and based on the communication module receiving the signal associated with the first end portion of the stylus device being activated, and
the modification module configured to send a signal to the presentation module to cause a second modification of the graphical user interface based on the input module detecting the second touch event and based on the communication module receiving the signal associated with the second end portion of the stylus device being activated.

18. The apparatus of claim 17, wherein the second modification of the graphical user interface is an ink smearing modification.

19. The apparatus of claim 17, wherein the input module is configured to distinguish between touch events associated with the stylus device and touch events associated with a portion of a user's body.
